(19) United States
(12) Patent Application Publication
(10) Pub. No.: US 2006/0242107 A1
(43) Pub. Date: Oct. 26, 2006

(54) Method and system for sharing digital database

(76) Inventors: Zechary Chang, Taipei (TW); Bing Bian, Beijing (CN); Pinky Ma, Beijing (CN)

Correspondence Address: RABIN & BERDO, P.C., 1101 14 Street, N.W., Suite 500, Washington, DC, 20005, US

(21) Appl. No.: 11/113,240

(22) Filed: Apr. 25, 2005

(51) Int. Cl. G06F 17/30

(52) U.S. Cl. 707/1

(57) ABSTRACT

A method and a system for sharing a digital database. The system has a client platform, a server platform and a network. The database of the client platform has the same data format as the database of the server platform. Via the network, database sharing between the client platform and the server platform is performed, such that the storage space occupied by the digital data is reduced.

### BACKGROUND OF THE INVENTION

The present invention relates in general to a method and a system for sharing database, and more particularly, to a method and a system for sharing a digital database.

Modern technology has changed the manner of data management for human beings. The conventional paper data have been replaced by digital storage, renewal and sorting. By the digital process, editing and storing, data can be retrieved instantaneously. Data communication can also be enhanced to allow unlimited sharing.

Currently, based on different requirement of software, each computer is loaded with a specific digital database. As a result, the same digital data may be stored in different computers. The digital data used for different software programs cannot be renewed synchronously. For example, many educational or translation software programs require a dictionary database. However, different databases have to be provided for different platforms. This wastes a lot of storage space and is disadvantageous for data renewal and sharing.

### BRIEF SUMMARY OF THE INVENTION

A method and a system for sharing a digital database are provided to allow multiple platforms using the databases with the same data format, such that the database can be co-shared through a network, and the data storage space can be minimized.

Accordingly, the method for sharing a digital database applied to a client platform having a database includes activating an inquiry interface, inputting an inquiry information, confirming that the database of the client platform do not include the inquiry information, connecting a server platform having a server database having the same data format as database of the client platform through a network, generating and transmitting a data request signal to the server platform, and searching the server database.

Furthermore, the system for sharing a digital database includes a client platform having a client database, a network, and a server platform having a server database having the same data format as the client database, the server platform being connected to the client platform via the network. The client platform is operative to generate a data request signal to the server platform, and the server platform is operative to generate a search result signal to the client platform in response to the data request signal.

### BRIEF DESCRIPTION OF THE DRAWINGS

The above objects and advantages of the present invention will be become more apparent by describing in detail exemplary embodiments thereof with reference to the attached drawings in which:

FIG. 1 shows a system for sharing a digital database;

FIG. 2 shows the flow chart of a method for sharing a digital database; and

FIG. 3 shows the operational flow of a server platform.

### DETAILED DESCRIPTION OF THE INVENTION

A method and a system for sharing a digital database are provided, in which digital databases have the same data format. Therefore, by maintaining a server platform having very few or one large server database, the database can be shared by multiple individual client platforms.

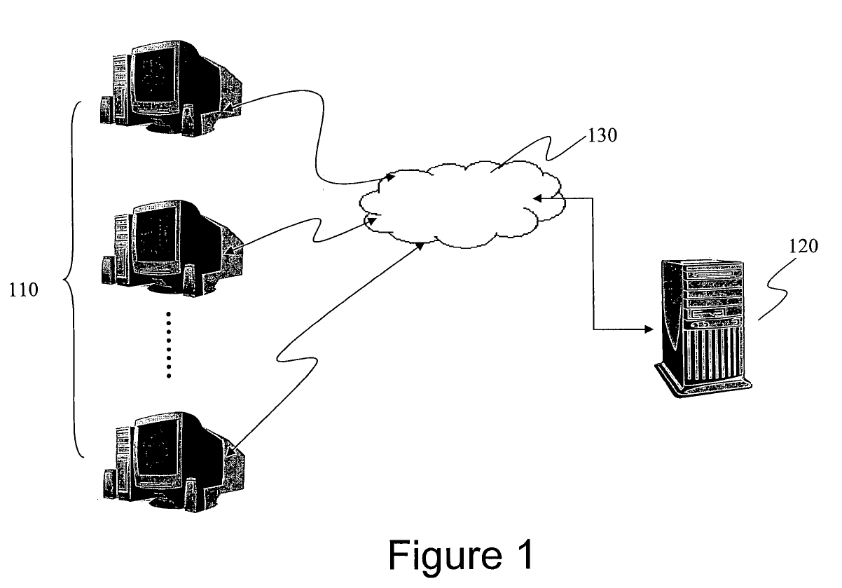

Referring to FIG. 1, the system for sharing digital databases includes multiple client platforms 110, a server platform 120 and a network 130. The client platforms 110 have databases in the same data format as that of the server platform 120. Via the connection of the network 130, the data are co-shared between the client platforms 110 and the server platform 120. The client platforms 110 include cellular phones, laptop computers or electronic dictionaries or other electronic devices connected through wired or wireless network. The server platform 120 includes a network server or an electronic device having data format the same as the client platforms 110. The network includes a wireless local network based on a transmission protocol such as infrared wireless transmission protocol, Bluetooth, IEEE802.11a standard, IEEE802.11b standard and Home RF, for example.

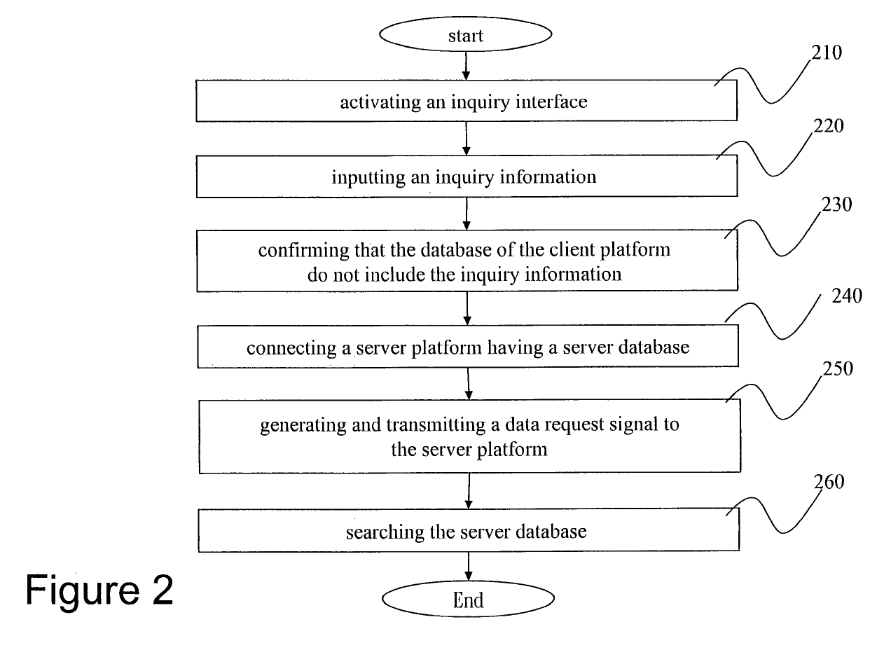

In the example of an electronic dictionary, the enquiry information is the keyword enquiry. The method of sharing database is performed by executing the system as discussed above. As shown in FIG. 2, in step 210, an inquiry interface is activated, and an inquiry keyword is input in step 220. When such keyword cannot be found in the database in step 230, the server platform having a server database is provided in step 240. A data request signal is generated and transmitted to the server platform, such that the server database is searched in step 250. A search result signal carrying the search result is then generated from the server platform in step 260. In the step of providing the server platform, the proximal server platform is provided first.

The data request signal preferably has a data format including the signal initial mark, client number, server number, inquiry information and signal ending mark. The search result signal preferably has a data format that includes a signal initial mark, a client number, a server number, an inquiry information, an information result and a signal ending mark.

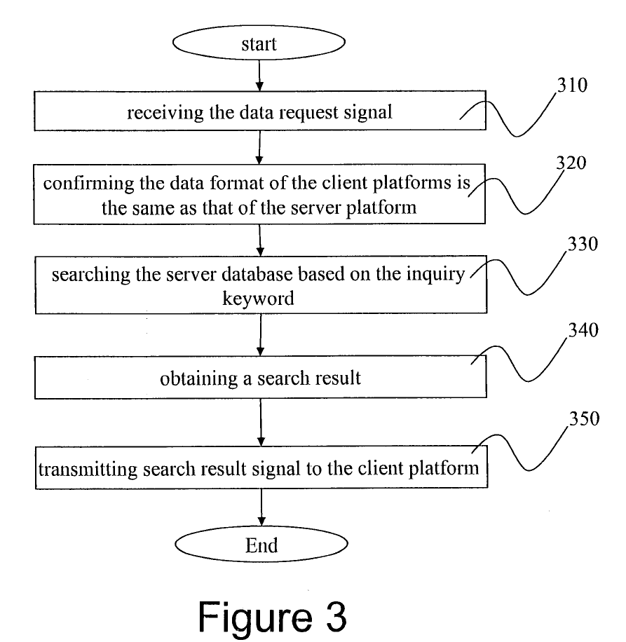

In addition, the above digital database sharing system includes the server platform and the client platforms, while the above embodiment is the operation flow at the client platforms. As a matter of fact, the process requires the interaction between the server platform and the client platforms. Referring to FIG. 3, the operation flow at the server platform is illustrated. The server platform is connected to the client platforms via the network. In step 310, the data request signal is received. The data request signal includes an inquiry keyword. In step 320, whether the data format of the client platforms is the same as that of the server platform is confirmed. When the data formats are the same, the server database is searched based on the inquiry keyword in step 330. A search result is then obtained, and a search result signal is generated in step 340. The search result signal is then transmitted to the client platform in step 350.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A method of sharing a digital database applied to a client platform having a database, comprising:
activating an inquiry interface;
inputting an inquiry information;
confirming that the database of the client platform do not include the inquiry information;
connecting a server platform having a server database having the same data format as database of the client platform through a network;
generating and transmitting a data request signal to the server platform; and
searching the server database.

2. The method of claim 1, wherein a proximal server platform is connected.

3. The method of claim 1, wherein the data request signal includes a data format having a signal initial mark, a client number, a server number, the inquiry information and a signal ending mark.

4. The method of claim 1, wherein the search result signal includes a signal initial mark, a client number, a server number, the inquiry information and a signal ending mark.

5. The method of claim 1, wherein the inquiry information includes a keyword.

6. The method of claim 1, wherein the network includes a wireless local network formed of a transmission protocol.

7. The method of claim 1, wherein the transmission protocol includes infrared wireless transmission protocol, Bluetooth, IEEE802.1 a standard, IEEE802.11b standard or Home RF.

8. A system for sharing a digital database, comprising:
a client platform having a client database;
a network; and
a server platform having a server database having the same data format as the client database, the server platform being connected to the client platform via the network; wherein
the client platform is operative to generate a data request signal to the server platform, and the server platform is operative to generate a search result signal to the client platform in response to the data request signal.

9. The system of claim 8, wherein the data request signal having a data format including a signal initial mark, a client number, a server number, an inquiry information and a signal ending mark.

10. The system of claim 8, wherein the search result signal having a data format including a signal initial mark, a client number, a server number, an inquiry information and a signal ending mark.

11. The system of claim 8, wherein the network includes a wireless local network formed of a transmission protocol.

12. The system of claim 11, wherein the transmission protocol includes infrared wireless transmission protocol, Bluetooth protocol, IEEE802.11a standard, IEEE802.11b standard, or Home RF.
